(19) United States
(12) Patent Application Publication
(10) Pub. No.: US 2023/0332982 A1
(43) Pub. Date: Oct. 19, 2023

(54) METHOD FOR MONITORING A SENSOR ARRANGED IN AN EXHAUST GAS REGION OF AN INTERNAL COMBUSTION ENGINE

(71) Applicant: Robert Bosch GmbH, Stuttgart (DE)

(72) Inventors: Jens Grimminger, Leonberg (DE); Niklas Ulshoefer, Sachsenheim (DE); Bernhard Kamp, Tamm (DE)

(21) Appl. No.: 18/245,613

(22) PCT Filed: Sep. 8, 2021
(86) PCT No.: PCT/EP2021/074633

§ 371 Date: Mar. 16, 2023

(30) Foreign Application Priority Data
Sep. 29, 2020 (DE) 10 2020 212 231.8

(51) Int. Cl. G01M 15/10; F02D 41/22; G07C 5/08

(52) U.S. Cl. CPC G01M 15/102; F02D 41/222; G07C 5/0808

(57) ABSTRACT

A method for monitoring a sensor arranged in the exhaust gas region of an internal combustion engine. The method includes determining a sensor temperature using the sensor, determining a model temperature of the sensor, integrating changes in the sensor temperature and integrating changes in the model temperature if the changes in the sensor temperature exceed a predetermined first threshold value and the changes in the model temperature exceed a predetermined second threshold value, and comparing the integral of the changes in the sensor temperature with a predetermined fourth threshold value.

### BACKGROUND INFORMATION

Numerous sensors which are used in an exhaust gas region of an internal combustion engine are described in the related art.

The present invention will be described in the following without limiting other embodiments and applications, in particular with reference to sensors for detecting particles or particulate matter, in particular soot particles in an exhaust gas flow of an internal combustion engine.

The use of two electrodes disposed on a ceramic to measure a concentration of particles, such as soot or dust particles, in an exhaust gas is conventional in practice. This can be done by measuring the electrical resistance of the ceramic material separating the two electrodes, for instance. More specifically, it is the electrical current flowing between the electrodes when an electrical voltage is applied to them that is measured. The soot particles settle between the electrodes as a result of electrostatic forces and, over time, form electrically conductive bridges between the electrodes. The more of these bridges there are, the more the measured current increases. This thus creates an increasing short-circuiting of the electrodes. The sensor element is regenerated prior to each measurement by heating it to at least 700° C. with an integrated heating element, as a result of which the soot deposits are burned off.

Such sensors therefore operate on the principle of resistive measurement of a soot mass accumulated on a sensor element over a longer measuring period. Such sensors are used in an exhaust gas line of an internal combustion engine, such as a diesel-type internal combustion engine, for example. These sensors are typically located downstream of the exhaust valve or soot particle filter and are used to monitor the soot particle filter.

For exhaust gas sensors, such as particle sensors, it is necessary to monitor whether they are installed in the exhaust gas line as intended. This can be achieved using the following diagnostics: removal detection via measurement of the temperature of the sensor element. If a modeled minimum temperature of the exhaust gas line is reached and the temperature of the sensor element falls below a threshold value, removal is identified. This occurs when the sensor element is not being heated, i.e., during the measurement phase. Alternatively, a protective tube diagnosis is carried out. If changes in the exhaust gas flow rate result in no or too little change in the heating power for regulating a constant sensor element temperature, removal or clogged protective tube is identified. The application of this diagnosis is laborious.

A method and a device for monitoring a component disposed in an exhaust gas region in an internal combustion engine is described in German Patent Application No. DE 10 2009 003 091 A1.

Despite the numerous advantages of the conventional devices and methods from the related art for monitoring a sensor disposed in an exhaust gas region of an internal combustion engine, there is still potential for improvement. Due to the tolerances of the model temperature of the exhaust gas line and the sensor temperature, for instance, the removal detection can only be enabled if the difference between the model and sensor temperature is sufficiently high, i.e., if the model temperatures are sufficiently high. In vehicles in which the particle sensor is installed at a comparatively cool location, this causes problems in terms of the enabling frequency of the diagnosis.

### SUMMARY

A method and an apparatus for monitoring a sensor disposed in an exhaust gas region of an internal combustion engine are provided according to the present invention, which at least largely avoid the disadvantages of conventional monitoring methods and which in particular create an evaluation for the identification of a removed sensor which is based on the evaluation of temperature changes and does not depend on the absolute temperature value, so that the diagnosis can be enabled at lower temperatures compared to the method described in the related art.

In the context of the present disclosure, the terms “first”, “second”, “third”, “fourth” and the like are used merely to differentiate specific features or components and are not intended to indicate any specific order, such as a weighting.

In a first aspect of the present invention, a method for monitoring a sensor disposed in an exhaust gas region of an internal combustion engine is provided. According to an example embodiment of the present invention, the method comprises determining a sensor temperature by means of the sensor. The sensor temperature can be determined directly or indirectly by means of the sensor.

According to an example embodiment of the present invention, the method further comprises determining a model temperature of the sensor. The model temperature approximates a temperature at an installation location of the sensor. In other words, for the model temperature, a temperature is considered that should reflect the temperature measured by the sensor at the location of the installed sensor as accurately as possible. The model temperature can be created using real or modeled temperature sources. In practice, a weighted average (calibratable) of the exhaust gas temperature and the wall temperature at the sensor installation location is used as the model temperature for the sensor. Real temperature sensors can be used for the exhaust gas and wall temperatures if any are available at suitable locations in the (vehicle) exhaust tract, or the exhaust gas and wall temperatures are modeled.

The method further comprises integrating changes in the sensor temperature and integrating changes in the model temperature if the changes in the sensor temperature exceed a predetermined first threshold value and the changes in the model temperature exceed a predetermined second threshold value. Therefore, the temperature changes are integrated only if the respective threshold values are exceeded. The method further comprises comparing the integral of the changes in the sensor temperature with a predetermined fourth threshold value. The changes in the sensor temperature and the model temperature are preferably temperature increases.

The evaluation method according to the present invention makes use of the fact that the sensor temperature does not show any significant increases when the sensor has been removed. An installed sensor, on the other hand, follows the model temperature of the exhaust gas system to some extent. The method is based on a correlation of the temperature increases of the model temperature of the exhaust gas system and the sensor temperature. The correlation is implemented by integrating the temperature increases of the model and sensor temperature when the increases exceed a definable threshold. By selecting suitable integration thresholds, signal noise and non-relevant temperature increases can be ignored. If insufficient agreement is observed, a diagnostic error can be set and a sensor removal can thus be identified.

The term “integral” as it is used here is a broad term which is to be accorded its usual and common meaning as it is understood by a person skilled in the art. The term is not restricted to a specific or adapted meaning. The term can refer, without restriction, in particular to a generic term for the indefinite integral and the definite integral. The calculation of integrals is called integration. The definite integral of a function assigns a number to it. If the definite integral of a real function is formed in a variable, the result can be interpreted in the two-dimensional coordinate system as the surface area of the area that lies between the graph of the function, the x-axis and the limiting parallels to the y-axis. Area segments below the x-axis are counted negatively. This is referred to as the oriented surface area (also area balance). This convention is selected so that the definite integral is a linear mapping, which is a central characteristic of the integral term for both theoretical considerations and specific calculations. This also ensures that the so-called fundamental theorem of differential and integral calculation applies. The indefinite integral of a function assigns to it a set of functions the elements of which are referred to as antiderivatives. These are characterized in that their first derivatives agree with the function that has been integrated. The fundamental theorem of differential and integral calculation provides information about how definite integrals can be calculated from antiderivatives.

According to an example embodiment of the present invention, the method can further comprise comparing the integral of the changes in the sensor temperature with the predetermined fourth threshold value if the integral of the changes in the model temperature exceeds a predetermined third threshold value. Thus, the evaluation is carried out if sufficient temperature increases have been observed, i.e., the integral of the positive model temperature changes reaches a calibratable threshold value.

The determination of the model temperature is based at least on an exhaust gas temperature and/or a wall temperature of the exhaust gas region at an installation location of the sensor.

According to an example embodiment of the present invention, the method can further comprise low-pass filtering of the sensor temperature and/or the model temperature. The sensor and/or model temperature can accordingly be low-pass filtered for signal smoothing. The term “low-pass filtering” as it is used here is a broad term which is to be accorded its usual and common meaning as it is understood by a person skilled in the art. The term is not restricted to a specific or adapted meaning. The term can refer, without restriction, in particular to filtering by means of a low-pass filter. In electronics, a filter which allows signal components with frequencies below its cutoff frequency to pass through almost unattenuated, while attenuating components with higher frequencies, is referred to as a low-pass filter. In communications engineering, the cutoff frequency is the frequency value above which the signal amplitude (voltage) or the modulation amplitude at the output of a component drops below a specific value.

According to an example embodiment of the present invention, the method can further comprise forming a sensor temperature quotient and/or a model temperature quotient with a predetermined time step. To be able to observe temperature changes, the difference quotients of both temperatures are formed with a selectable time step dt.

According to an example embodiment of the present invention, the method can further comprise identifying a removal and/or functionally improper installation of the sensor if the integral of the changes in the sensor temperature falls below the predetermined fourth threshold value and identifying an installation and/or functionally proper installation of the sensor if the integral of the changes in the sensor temperature reaches or exceeds the predetermined fourth threshold value. An error, i.e., a sensor removal, is thus identified if at this time the integral of the positive sensor temperature changes is less than a calibratable threshold, otherwise an intact result is reported.

The sensor can be a particle sensor.

The term “particle sensor” as it is used here is a broad term which is to be accorded its usual and common meaning as it is understood by a person skilled in the art. The term is not restricted to a specific or adapted meaning. The term can refer, without restriction, in particular to a sensor configured to detect particles or particulate matter. The particles are preferably electrically conductive particles. The principle of operation of the particle sensor is based on the measurement of resistance. Soot particles settle on an electrode structure and form conductive soot paths between the electrodes. Prior to each measurement phase, the sensor element is regenerated by heating in order to obtain a defined state of the sensor element at the start of the measurement process.

The internal combustion engine can be a diesel engine, wherein the method can be carried out in the context of on-board diagnostics of the diesel engine.

In another aspect of the present invention, an apparatus for monitoring a sensor disposed in an exhaust gas region of an internal combustion engine is provided. According to an example embodiment of the present invention, the apparatus comprises a control, wherein the control is configured to carry out the method according to any one of the embodiments disclosed herein. The control can be implemented in a control device, such as in an engine control device.

In another aspect of the present invention, a computer program is provided, which is configured to carry out every step of the method according to any one of the embodiments disclosed herein.

In another aspect of the present invention, an electronic storage medium is provided, on which such a computer program is stored.

In another aspect of the present invention, an electronic control device comprising such an electronic storage medium is provided.

### BRIEF DESCRIPTION OF THE DRAWINGS

Other optional details and features of the present invention will emerge from the following description of preferred embodiment examples which are shown schematically in the figures.

FIG. 1 shows the technical environment in which the method according to the present invention can be used.

FIG. 2 shows schematically, the sensor element of a sensor embodied as a particle sensor in plan view.

FIG. 3 shows a flowchart of the method according to an example embodiment of the present invention.

FIG. 4 shows example progressions of the temperatures and integrals of the positive temperature changes in the intact case.

FIG. 5 shows example progressions of the temperatures and integrals of the positive temperature changes in the defect case.

### DETAILED DESCRIPTION OF EXAMPLE EMBODIMENTS

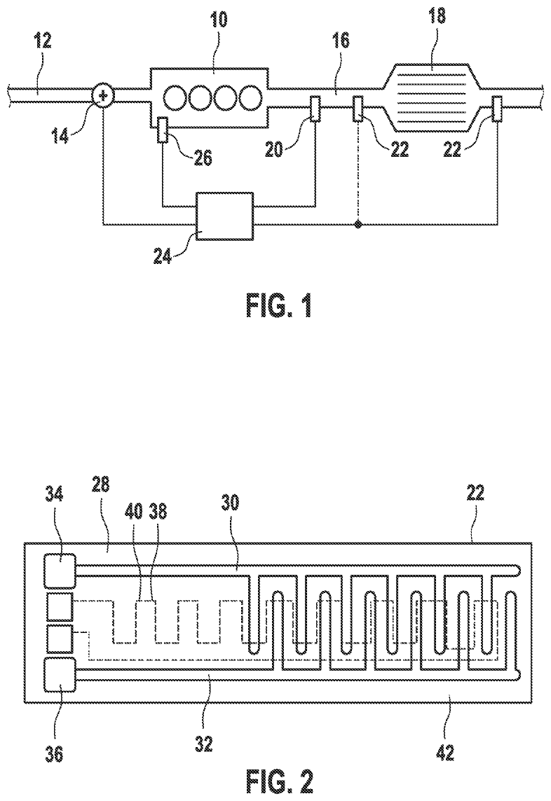

FIG. 1 shows the technical environment in which the method according to the present invention can be used. The technical environment can also comprise exhaust gas aftertreatment devices which include measures to mitigate at least one other statutorily limited component, e.g., NOx mitigation measures.

An internal combustion engine 10, which can be embodied as a diesel engine, is supplied with combustion air via an air feed inlet 12. The quantity of combustion air can be determined by means of an air mass flow meter 14 in the air feed inlet 12. The quantity of air can be used in a correction of an accumulation probability of particles present in the exhaust gas from the internal combustion engine 10. The exhaust gas from the internal combustion engine 10 is discharged via an exhaust gas line 16 in which an exhaust emission control system 18 is disposed. This exhaust emission control system 18 can be embodied as a diesel particle filter. Also disposed in the exhaust gas line 16 in the shown example are an exhaust gas probe 20 embodied as a lambda probe and a sensor 22 embodied as a particle sensor, the signals of which are fed to an engine control 24. Viewed in the direction of flow of the exhaust gas, the sensor 22 is disposed downstream of the exhaust emission control system 18. The engine control 24 is also connected to the air mass flow meter 14 and, based on the data provided to it, determines a fuel quantity that can be delivered to the internal combustion engine 10 via a fuel metering unit 26. The sensor 22 or an additional sensor 22 can also be disposed upstream of the exhaust emission control system 18 in the direction of flow of the exhaust gas. The shown apparatuses make it possible to observe the particle emissions of the internal combustion engine 10 (on-board diagnostics) and to predict the load on and/or identify a defect of the exhaust emission control system 18 configured as a diesel particle filter (DPF).

FIG. 2 shows a schematic illustration of a sensor element of a sensor 22 embodied as a particle sensor in plan view. A first electrode 30 and a second electrode 32 are applied to an insulating carrier 28, for example made of aluminum oxide. The electrodes 30, 32 are embodied as two interdigital, intermeshing comb electrodes. A first connector 34 and a second connector 36, via which the electrodes 30, 32 can be connected to a not-depicted control unit for voltage supply and for carrying out the measurement, are provided on the end faces of the electrodes 30, 32. The sensor 20 further comprises a temperature sensor 38 that can be used to directly determine a sensor temperature. The temperature sensor 38 can be embodied as a platinum meander, wherein additional electrodes determine a temperature-dependent resistance, which can be evaluated in the engine control 24.

The sensor 22 further comprises a heating element 40, which is integrated in the carrier 28, and an optional protective layer 42. It can be provided that the heating element 40 is simultaneously embodied as a temperature sensor 38, or that the heating element 40 and the temperature sensor 38 are embodied as separate electrical conductors with separate electrodes.

The mode of operation of such particle sensors has already been adequately described in the literature and will therefore be described only briefly in the following.

If such a sensor 22 is operated in a gas flow carrying particles, for example in an exhaust duct of a diesel engine, particles from the gas flow will settle on the sensor 22. In the case of the diesel engine, the particles are in particular soot particles with a corresponding electrical conductivity. The rate at which the particles settle on the sensor 22 depends not only on the particle concentration in the exhaust gas but, among other things, also on the voltage applied to the electrodes 30, 32. The applied voltage generates an electrical field which exerts a corresponding attraction on electrically charged particles and particles having a dipole charge. The rate at which the particles settle can therefore be influenced by a suitable selection of the voltage applied to the electrodes 30, 32.

In the embodiment example, at least the lead portions of the electrodes 30, 32 and the carrier 28 are coated on the electrode side with the optional protective layer 42. The optional protective layer 42 protects the electrodes 30, 32 from corrosion at the high operating temperatures of the sensor 22 that usually prevail. In the present embodiment example, it is made of a material having a low conductivity, but it can also be made of an insulator.

After a certain amount of time, particles from the gas flow have settled on the protective layer 42 in the form of a layer. Due to the low conductivity of the protective layer 42, the particles form a conductive path between the electrodes 30, 32, so that, depending on the quantity of deposited particles, there is a change in resistance between the electrodes 30, 32. This can be measured, for example, by applying a constant voltage to the connectors 34, 36 of the electrodes 30, 32 and determining the change in the current due to the accumulated particles.

If the protective layer 42 has an insulating structure, the deposited particles lead to a change in the ohmic resistance of the sensor 22, which can be evaluated by means of a corresponding measurement, preferably with a DC voltage.

The diagnostic method according to the present invention is described in more detail in the following. The functionality of the method according to the present invention with the variants described above or in the following can be implemented particularly advantageously as software in the engine control 24 of the internal combustion engine 10, in diesel internal combustion engines in the electronic diesel control (EDC) system. The engine control 24 can therefore be used by its control as an apparatus or control device to carry out the method. The method is carried out in the context of on-board diagnostics of the diesel engine, for example.

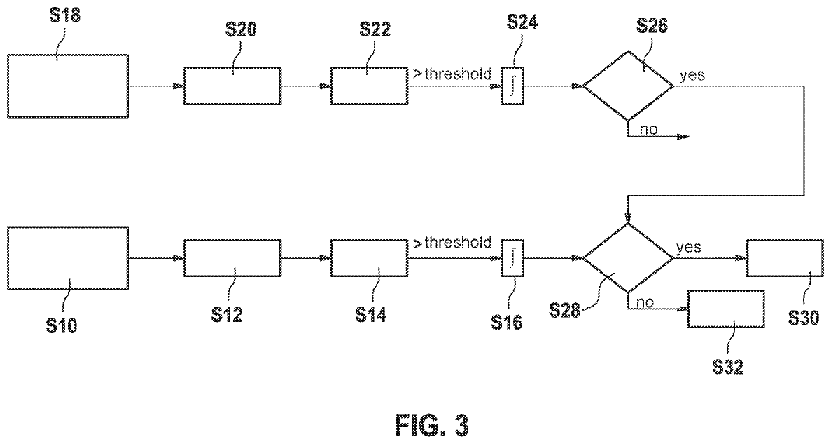

FIG. 3 shows a flowchart of the method according to the present invention. In step S10, the method according to the present invention provides that a sensor temperature is determined by means of the sensor 22. The sensor temperature can be determined directly or indirectly. In a subsequent step S12, the sensor temperature is low-pass filtered. Changes in temperature and in particular increases in the temperature of the sensor temperature are recorded as well. In order to be able to observe temperature changes, a difference quotient of the sensor temperature is formed with a predetermined time step dt in a subsequent step S14. If the changes in the sensor temperature exceed a predetermined first threshold value, the changes in the sensor temperature are integrated in step S16. The first threshold value is selected such that changes due to signal noise are hidden. Small changes for which no corresponding counterpart can be found in the changes in a model temperature of the sensor 22 are not taken into account. The focus here is not on a comparison of temperature changes within a single time step, but within a longer period of time, for example of several seconds.

In parallel to steps S10 to S16, the method provides in step S18 that the model temperature of the sensor 22 is determined. The model temperature can be determined by means of another sensor, for example. The model temperature is based at least on an exhaust gas temperature and/or a wall temperature of the exhaust gas region at an installation location of the sensor. In a subsequent step S20, the model temperature is low-pass filtered. Changes in temperature and in particular increases in the temperature of the model temperature are recorded as well. In order to be able to observe temperature changes, a difference quotient of the model temperature is formed with a predetermined time step dt in a subsequent step S22. If the changes in the model temperature exceed a predetermined second threshold value, the changes in the model temperature are integrated in step S24. The second threshold value is selected such that changes due to signal noise are hidden. The only model temperature increases that are taken into account are those for which a corresponding reaction of the sensor temperature can be observed as well. The focus here is not on a comparison of temperature changes within a single time step, but within a longer period of time, for example of several seconds.

If the integral of the changes in the model temperature exceeds a predetermined third threshold value in a subsequent step S26, the integral of the changes in the sensor temperature is compared with a predetermined fourth threshold value in a step S28. Otherwise, the method ends after step S26. If the integral of the changes in the sensor temperature falls below the predetermined fourth threshold value in step S28, a removal and/or functionally improper installation of the sensor 22 is identified in step S30. If the integral of the changes in the sensor temperature reaches or exceeds the predetermined fourth threshold value in step S28, an installation and/or functionally proper installation of the sensor 22 is identified in step S32.

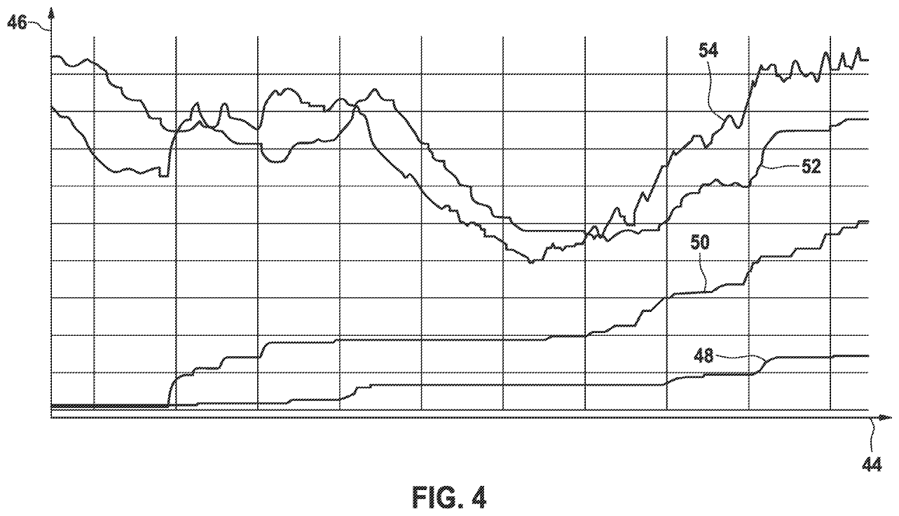

FIG. 4 shows example progressions of the temperatures and integrals of the positive temperature changes in the intact case. The time is plotted on the x-axis 44. The y-axis 46 shows the sensor temperature, the model temperature, the integral of the positive sensor temperature changes and the integral of the positive model temperature changes. The curve 48 represents the progression of the sensor temperature. The curve 50 represents the progression of the model temperature for the sensor. The curve 52 represents the progression of the integral of the positive sensor temperature changes. The curve 54 represents the progression of the integral of the positive model temperature changes. As can be seen from FIG. 4, when the sensor 22 is intact, the sensor temperature follows the model temperature, so that the curves 52 and 54 have a similar progression of the respective integrals.

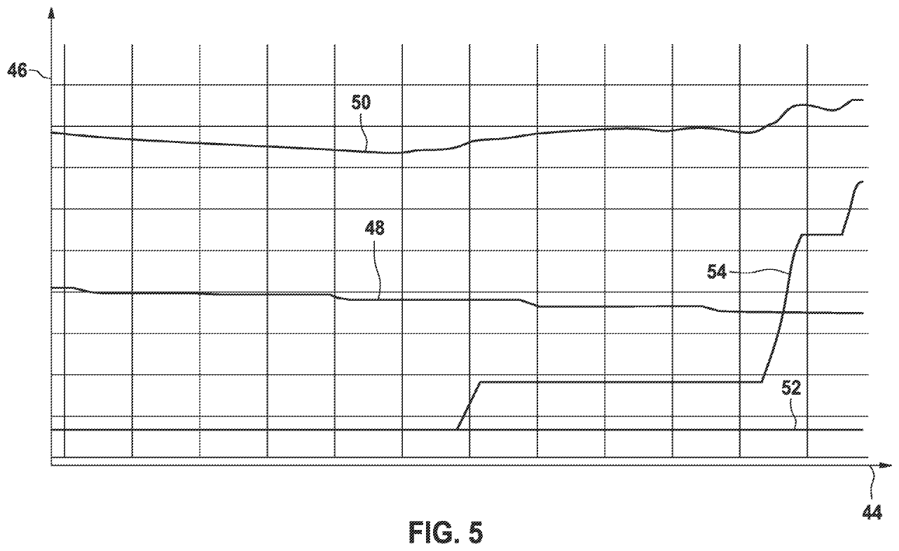

FIG. 5 shows example progressions of the temperatures and integrals of the positive temperature changes in the defect case. Only the differences to FIG. 4 are discussed in the following and the same or comparable features are provided with the same reference signs. As can be seen from FIG. 5, when the sensor 22 is defective, the sensor temperature does not follow the model temperature. The sensor temperature thus remains constant as the model temperature increases, as can be seen from curves 48 and 50. The curve 54 therefore increases, but not the curve 52.

Another advantage of this evaluation method lies in the expectation of a high selectivity, because the integral of the sensor temperature changes will increase not at all or only slightly in the defect case. The defect threshold can thus be set very low, which also enables an evaluation after comparatively few model temperature increases. In exceptional cases, a sensor temperature increase in the defect case can be caused by the influence of trapped heat, for example if the vehicle is parked in the garage immediately after a trip with high engine load. The temperature increase in such a scenario will firstly be low and secondly comparatively slow, however, so that integration of such increases can be prevented by a suitable selection of the integration threshold.

The evaluation method implemented in this invention utilizes temperature changes, which means that it requires a comparatively dynamic driving style. The currently used methods tend to assume static conditions with little changes in the model temperature. The evaluation methods thus cover complementary travel conditions, which is why they can advantageously both be used at the same time to identify a removed sensor. In this case, the method that arrives at a diagnostic result first can trigger the setting of the error. The exclusive use of the described new evaluation method is possible too.

The use of the present invention can be demonstrated by an analysis of the relevant software. The present invention could also be demonstrated in the manner in which a corresponding diagnosis is to be applied to sensor removal. A demonstration would moreover be possible if a sensor is operated with a control device according to the present invention and relevant software.

1-12. (canceled)

13. A method for monitoring a sensor arranged in the exhaust gas region of an internal combustion engine, comprising the following steps:
determining a sensor temperature using the sensor;
determining a model temperature of the sensor;
integrating changes in the sensor temperature and integrating changes in the model temperature when the changes in the sensor temperature exceed a predetermined first threshold value and changes in the model temperature exceed a predetermined second threshold value; and
comparing the integral of the changes in the sensor temperature with a predetermined fourth threshold value.

14. The method according to claim 13, further comprising:
comparing the integral of the changes in the sensor temperature with the predetermined fourth threshold value when the integral of the changes in the model temperature exceeds a predetermined third threshold value.

15. The method according to claim 13, wherein the determination of the model temperature is based at least on an exhaust gas temperature and/or a wall temperature of the exhaust gas region at an installation location of the sensor.

16. The method according to claim 13, further comprising low-pass filtering the sensor temperature and/or the model temperature.

17. The method according to claim 13, further comprising:
forming a sensor temperature quotient and/or a model temperature quotient with a predetermined time step.

18. The method according to claim 13, further comprising:
identifying a removal and/or functionally improper installation of the sensor when the integral of the changes in the sensor temperature falls below the predetermined fourth threshold value, and identifying an installation and/or functionally proper installation of the sensor when the integral of the changes in the sensor temperature reaches or exceeds the predetermined fourth threshold value.

19. The method according to claim 13, wherein the sensor is a particle sensor.

20. The method according to claim 13, wherein the internal combustion engine is a diesel engine, wherein the method is carried out in the context of on-board diagnostics of the diesel engine.

21. An apparatus configured to monitor a sensor arranged in an exhaust gas region of an internal combustion engine, wherein the apparatus comprises:
a control configured to:
determine a sensor temperature using the sensor;
determine a model temperature of the sensor;
integrate changes in the sensor temperature and integrate changes in the model temperature when the changes in the sensor temperature exceed a predetermined first threshold value and changes in the model temperature exceed a predetermined second threshold value; and
compare the integral of the changes in the sensor temperature with a predetermined fourth threshold value.

22. A non-transitory computer-readable medium on which is stored a computer program for monitoring a sensor arranged in the exhaust gas region of an internal combustion engine, the computer program, when executed by a processor, causing the processor to perform the following steps:
determining a sensor temperature using the sensor;
determining a model temperature of the sensor;
integrating changes in the sensor temperature and integrating changes in the model temperature when the changes in the sensor temperature exceed a predetermined first threshold value and changes in the model temperature exceed a predetermined second threshold value; and
comparing the integral of the changes in the sensor temperature with a predetermined fourth threshold value.

23. An electronic control device for monitoring a sensor arranged in the exhaust gas region of an internal combustion engine, the electronic control device configured to:
determine a sensor temperature using the sensor;
determine a model temperature of the sensor;
integrate changes in the sensor temperature and integrate changes in the model temperature when the changes in the sensor temperature exceed a predetermined first threshold value and changes in the model temperature exceed a predetermined second threshold value; and
compare the integral of the changes in the sensor temperature with a predetermined fourth threshold value.
